(19) United States
(12) Patent Application Publication
(10) Pub. No.: US 2013/0302767 A1
(43) Pub. Date: Nov. 14, 2013

(54) INTERACTIVE KISOKS SYSTEM AND METHOD FOR REWARDS BASED EDUCATION

(71) Applicant: THE KELLY TOUCH, LLC, Carmel, IN (US)

(72) Inventor: Kelly T. Hipskind, Carmel, IN (US)

(73) Assignee: THE KELLY TOUCH, LLC, Carmel, IN (US)

(21) Appl. No.: 13/837,536

(22) Filed: Mar. 15, 2013

Related U.S. Application Data
(60) Provisional application No. 61/644,481, filed on May 9, 2012.

(51) Int. Cl. G09B 19/00

(52) U.S. Cl. CPC G09B 19/00
USPC 434/238

(57) ABSTRACT

A computer implemented student attendance tracking and award credit accumulation system in which class and school attendance data associated with a student is tracked, recorded and reported to select parties in real-time. In the computer implemented system and method, a student earns award credits for class and school attendance, in real-time, and the system immediately updates an accumulation balance of student award credits stored within data storage at a web based interface server. The system includes a plurality of data input terminals and a web based interface server, wherein the input terminals may comprise kiosks, desktop workstations and/or laptops. Each data input terminal includes a student identification retrieval device and is configured for retrieving student identification data for input into the web based interface server. The student identification retrieval device may comprise a card swipe communication system or an RFID receiver for receiving student identification data from identification data transmitted from an RFID identifier attached and stored on a student identification card.

### CROSS-REFERENCE TO RELATED APPLICATION

This patent application claims the benefit of provisional patent application No. 61/644,481, filed May 9, 2012, the disclosures of which are incorporated herein by reference in their entirety.

### BACKGROUND

### Field of the Invention

The present invention generally relates to methods and systems relating to rewarding students in an educational environment for achieving defined academic standard levels including attendance. More specifically the system relates to an

automated system and method of capturing student metrics, processing the metrics, generating reports relating to the captured metrics in real-time and providing students with awards/rewards and award/reward notifications in real-time in response to student achievement of defined student metric levels. The system and method provides for individualized and group student metric level plan creation that controls student reward generation.

Despite efforts to increase the quality of American education, many children continue to perform poorly in school. There are a number of reasons that have been identified as causing poor student performance, including but not limited to, poor eyesight, poor hearing, problems at home and, excessive ambition. Lack of motivation, the opposite of excessive ambition has been identified as one of the main factors that lead to poor student performance. Many children do not exert themselves fully in classroom assignments and homework because the benefits, such as increased earnings and well-roundedness, are not immediate and will not be appreciated for several years.

In an effort to address this problem, numerous alternatives to the traditional classroom method of learning have emerged. One such alternative is known as rewards-based education. These systems reward students upon accomplishing certain educational goals. This reinforcement is meant to motivate the students to work harder at school-related tasks.

One such system is a system Ainsworth Elementary in Portland, Oreg., where students are rewarded with “Birdie Bucks” that may be collected and spent in a classroom store. Students receive a $1 Birdie Buck for each day they turn in homework on time and complete. Students also receive a Birdie Buck if they have no warnings or timeouts during the day. On a defined day, students are able to buy things from a ‘Birdie Store’ stocked with items that are age appropriate that the students desire to obtain. The Birdie Buck system rewards students who do not typically have behavior problems, and at the same time it is an easy incentive program with instant rewards and high student interest.

Students know they can earn rewards in two areas, homework and behavior, so they have an opportunity to earn rewards even if they are not good in one of the two areas. In the Birdie Buck system, class members receive one buck each day for following directions, having no time-outs, and trying their hardest. They receive another for doing the day's homework. Students find an item that they want in the store and actively work on earning “birdie bucks” to purchase it. Birdie Bucks are simply a way to motivate students to change their behavior.

Some of the drawbacks of reward systems such as the Birdie Bucks system are that they are time consuming to manage, make additional work for teachers that are already over worked and do not provide an effective means for communicating student compliance to defined standards. Another drawback of these type of reward systems is that they are essentially one size fits all programs, which don't allow for all students to be motivated, as some may be already performing the behavior being rewarded and others are so far off the mark that they never get rewards, which may make them even stop trying at all, if they are not able to participate. There is a need for a student award/reward program that provides for individualized award/reward methods that enable each student to participate and receive rewards for modifying behavior that a respective teacher or administrator is attempting to achieve with that student.

Another problem with systems such as the Birdie Bucks system is that they do not enable teachers, administrators, district personnel and parents to track the behavior that is being rewarded. There is a need for a system to be able to automatically track the behavior being rewarded and generate reports illustrating improvement levels by student, classroom, school district, city and state levels. Such information, if generated automatically and presented in real-time shall assist with student management as well as have the desired student impact, to the extent students may receive individualized feedback immediately.

### SUMMARY OF THE INVENTION

Consistent with embodiments of the present invention, systems and methods are disclosed for a computer implemented student attendance tracking and award credit accumulation system in which class and school attendance data associated with a student is tracked, recorded and reported to select parties in real-time. In the computer implemented system a student earns award credits for class and school attendance, in real-time, and the system immediately updates an accumulation balance of student award credit stored within data storage at a web based interface server. The system includes a plurality of data input terminals and a web based interface server. Each of the plurality of input terminals is configured for retrieving student identification data. In one embodiment a data input terminal is a kiosk that includes an interface screen for display of data transmitted from the web based interface server. In another embodiment the data input terminal is a desktop workstation or laptop. The kiosk is configured to include a student identification retrieval device and the desktop or laptop has a student identification retrieval device operatively connected thereto.

In one embodiment, the student identification retrieval device utilized in the present invention comprises a card swipe communication system operatively configured to determine student identification from a magnetic stripe on a student identification card. In another embodiment, the student identification retrieval device comprises a RFID receiver for receiving student identification data from identification data transmitted from an RFID identifier attached and stored on a student identification card. The web based interface server includes a storage area for storing student records including data representative of student personal information, student attendance and the student award credit accumulation balance. The system is also configured such that student identification data may be manually entered into the system to there by facilitate manual student check-in by a user accessing the system when the automated student identification components are not operational.

The plurality of data input terminals are connected to the web based interface server to facilitate transmission of student identification data to a processor within the web based interface server configured to receive student identification data to facilitate student check-in by logging the time of receipt of the student identification data as the student check-in time. The established student check in time is used to determine whether a student is on time for school or scheduled courses, and whether the student is absent from school or any scheduled courses on days for which the student is scheduled to be in school or courses and has not been excused. The web based interface server is configured to process each transmission of student identification data to determine school attendance data and in response to the time the student checks into the system determine whether the student shall be awarded attendance credits that are combined with the student award credit balance previously earned to create an updated student award credit balance. The student award credits earned upon the student satisfying pre-defined and programmed attendance and performance criteria shall be accumulated and added to the previously earned student award credit balance and stored in the web based interface server as an updated student award credit balance.

During operation, upon a determination by the system that a student is at least one of absent and tardy for at least one of a school day and a course, the web based interface server processes the student record associated with the student to determine notification instructions and transmits an email message to a previously stored email address, an SMS message to a previously stored SMS number, a text message to a previously stored mobile communication device number, and an automatically generated computer voice message to a previously stored land or mobile telephone number.

The system further includes data input devices connected to the web based interface server for accessing third party accounts that enable third party advertisers and award program participants to input advertising data within advertising data storage files that are processed by the web based interface server in order to display advertisements on an interface screen operatively connected to the web-based interface server for display of third party advertisements.

It is to be understood that both the foregoing summary of the invention and the following detailed description are exemplary and explanatory only, and should not be considered restrictive of the scope of the invention, as described and claimed. Further, features and/or variations may be provided in addition to those set forth herein

### BRIEF DESCRIPTION OF THE DRAWINGS

The accompanying drawings, which are incorporated in and constitute a part of this disclosure, illustrate various embodiments and aspects of the present invention. In the drawings:

FIG. 1 is a block diagram depicting an overall architecture for implementing the present invention according to one embodiment;

FIG. 2 is an illustration of an embodiment of the front of a student identification card;

FIG. 3 is an illustration of an embodiment of the back of a student identification card, illustrating an embodiment including an RFID chip;

FIG. 4 illustrates a GUI display of an embodiment of a user interface for selecting proper a proper access channel into the system and method;

FIG. 5 illustrates a GUI display of an embodiment of a login interface for accessing the system and method;

FIG. 6 illustrates a GUI display of an embodiment of the system and method illustrating attendance dashboard for a teacher's schedule of classes, illustrating summary student attendance data for each class;

FIG. 7 illustrates a GUI display of an embodiment of the system and method illustrating a specific student attendance dashboard for a specific class of a teacher's schedule of classes;

FIG. 8 illustrates a GUI display of an embodiment of the system and method illustrating a teacher dashboard enabling a teacher to take attendance manually and by swiping identification cards for a teacher's scheduled class;

FIG. 9 illustrates a GUI display of an embodiment of the system and method illustrating an administrator attendance dashboard utilized by an administrator of a school for real-time reporting of building wide student attendance data;

FIG. 10 illustrates a GUI display of an embodiment of the system and method illustrating an administrator attendance dashboard utilized by an administrator of a school for searching and filtering student attendance data by teacher;

FIG. 11 illustrates a GUI display of an embodiment of the system and method illustrating an administrator attendance dashboard utilized by an administrator of a school for searching and filtering student attendance data by courses;

FIG. 12 illustrates a GUI display of an embodiment of the system and method illustrating an administrator attendance dashboard utilized by an administrator of a school for searching and filtering student attendance data by individual student;

FIG. 13 illustrates a GUI display of an embodiment of a user interface displayed to users of the system and method following system login by a user by swiping or any other login method;

FIG. 14 illustrates a module component diagram an embodiment of the student award/reward interface module;

FIG. 15 illustrates a GUI display of an embodiment of a user interface displayed to users of the system and method following system determination that the user is eligible for rewards offered to member users; and

FIGS. 16 and 17 illustrates an embodiment of the process flow following student check-in to the attendance tracking system.

### GENERAL DESCRIPTION

Consistent with embodiments of the present invention, systems and methods are disclosed in which student class and school attendance data associated with a student is tracked, recorded and reported to select parties in real-time. In the computer implemented system a student earns award credits for class and school attendance, in real-time, and the system immediately updates an accumulation balance of student award credit stored within data storage at a web based interface server. The system includes a plurality of data input terminals and a web based interface server. Each of the plurality of input terminals is configured for retrieving student identification data. In one embodiment a data input terminal is a kiosk that includes an interface screen for display of data transmitted from the web based interface server. In another embodiment the data input terminal is a desktop workstation or laptop. The kiosk is configured to include a student identification retrieval device and the desktop or laptop has a student identification retrieval device operatively connected thereto by way of a USB connection.

In one embodiment, the student identification retrieval device comprises a card swipe communication system operatively configured to determine student identification from a magnetic stripe on a student identification card. In another embodiment, the student identification retrieval device comprises a RFID receiver for receiving student identification data from identification data transmitted from an RFID identifier attached and stored on a student identification card. The web based interface server includes a storage area for storing student records including data representative of student personal information, student attendance and the student award credit accumulation balance.

The plurality of data input terminals are connected to the web based interface server to facilitate transmission of student identification data to a processor within the web based interface server configured to receive student identification data to facilitate student check-in by logging the time of receipt of the student identification data as the student check-in time. The established student check in time is used to determine whether a student is on time for school or scheduled courses, and whether the student is absent from school or any scheduled courses on days for which the student is scheduled to be in school or courses and has not been excused. The web based interface server is configured to process each transmission of student identification data to determine school attendance data and in response to the time the student checks into the system determine whether the student shall be awarded attendance credits that are combined with the student award credit balance previously earned to create an updated student award credit balance. The student award credits earned upon the student satisfying pre-defined and programmed attendance and performance criteria shall be accumulated and added to the previously earned student award credit balance and stored in the web based interface server as an updated student award credit balance.

During operation, upon a determination by the system that a student is at least one of absent and tardy for at least one of a school day and a course, the web based interface server processes the student record associated with the student to determine notification instructions and transmits an email message to a previously stored email address, an SMS message to a previously stored SMS number, a text message to a previously stored mobile communication device number, and an automatically generated computer voice message to a previously stored land or mobile telephone number.

The system further includes data input devices connected to the web based interface server for accessing third party accounts that enable third party advertisers and award program participants to input advertising data within advertising data storage files that are processed by the web based interface server in order to display advertisements on an interface screen operatively connected to the web-based interface server for display of third party advertisements.

### DETAILED DESCRIPTION

The following detailed description refers to the accompanying drawings. Wherever possible, the same reference numbers are used in the drawings and the following description to refer to the same or similar parts. While several embodiments and features of the invention are described herein, modifications, adaptations and other implementations are possible, without departing from the spirit and scope of the invention. Rather these embodiments are provided so that this disclosure will be complete and will fully convey the invention to those skilled in the art. For example, substitutions, additions or modifications may be made to the components illustrated in the drawings, and the methods described herein may be modified by substituting, reordering or adding steps to the disclosed methods. Accordingly, the following detailed description does not limit the invention. Instead, the proper scope of the invention is defined by the appended claims.

In one embodiment, the present invention is implemented as a computer implemented student attendance tracking and award credit accumulation system in which class and school attendance data associated with a student is tracked, recorded and reported to previously identified select parties in real-time. In the computer implemented system a student earns award credits for class and school attendance, in real-time, and the system immediately updates an accumulation balance of student award credit stored within data storage at a web based interface server. The system includes a plurality of data input terminals and a web based interface server. Each of the plurality of data input terminals is configured for retrieving student identification data and transmitting such data to the systems web-based interface server. In one embodiment a data input terminal is a kiosk that includes an interface screen for display of data transmitted from the web based interface server. In another embodiment the data input terminal is a desktop workstation or laptop. The kiosk is configured to include a student identification data retrieval device to capture student identification data for system processing in order to facilitate student check-in. Similarly, the desktop or laptop has a student identification retrieval device operatively connected thereto, in one embodiment by way of a USB connection, to capture student identification data for system processing in order to facilitate student check-in.

In one embodiment, the student identification retrieval device comprises a card swipe communication system operatively configured to determine student identification from a magnetic stripe on a student identification card. In another embodiment, the student identification retrieval device comprises an RFID receiver for receiving student identification data from identification data transmitted from an RFID identifier attached and stored on a student identification card. The web based interface server includes a storage area for storing student records including data representative of student personal information, student attendance and the student award credit accumulation balance.

The plurality of data input terminals are connected to the web based interface server to facilitate transmission of student identification data to a processor within the web based interface server configured to receive student identification data to facilitate student check-in by logging the time of receipt of the student identification data as the student check-in time. The established student check in time is used to determine whether a student is on time for school or scheduled courses, and whether the student is absent from school or any scheduled courses on days for which the student is scheduled to be in school or courses and has not been excused. The web based interface server is configured to process each transmission of student identification data to determine school attendance data and in response to the time the student checks into the system determine whether the student shall be awarded attendance credits that are combined with the student award credit balance previously earned to create an updated student award credit balance. The student award credits earned upon the student satisfying pre-defined and programmed attendance and performance criteria shall be accumulated and added to the previously earned student award credit balance and stored in the web based interface server as an updated student award credit balance.

During operation, upon a determination by the system that a student is at least one of absent and tardy for at least one of a school day and a course, the web based interface server processes the student record associated with the student to determine notification instructions and transmits an email message to a previously stored email address, an SMS message to a previously stored SMS number, a text message to a previously stored mobile communication device number, and an automatically generated computer voice message to a previously stored land or mobile telephone number.

The system further includes data input devices connected to the web based interface server for accessing third party accounts that enable third party advertisers and award program participants to input advertising data within advertising data storage files that are processed by the web based interface server in order to display advertisements on an interface screen operatively connected to the web interface server for display of third party advertisements.

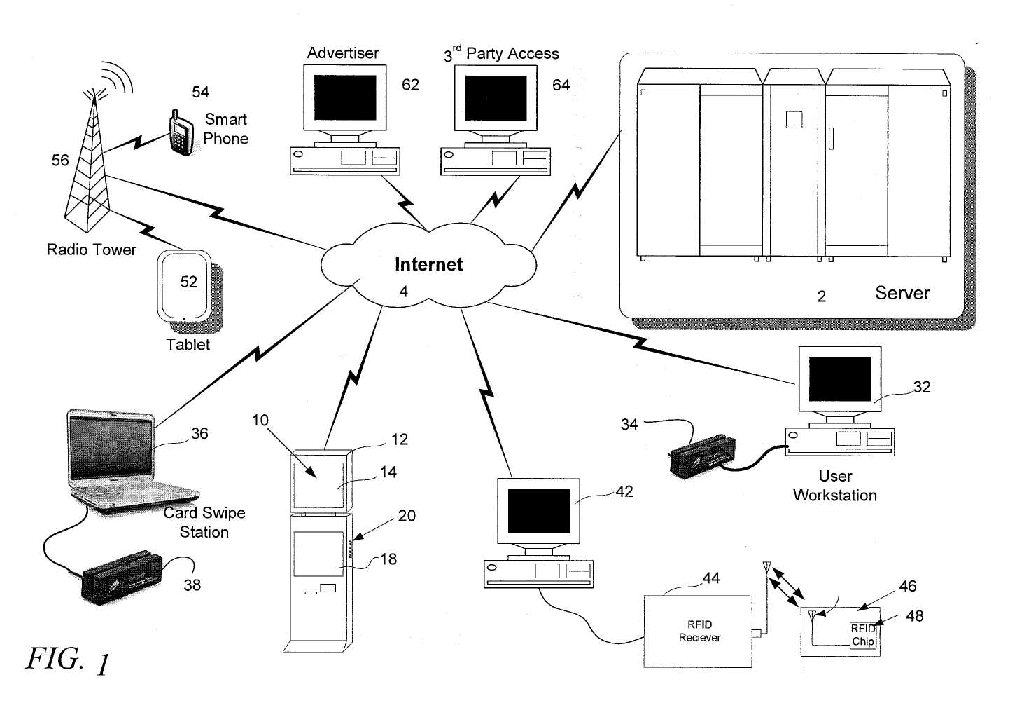

Referring to FIG. 1, an embodiment of computer implemented student school attendance tracking and award accumulation system is illustrated. The system disclosed tracks a student's attendance and award credit accumulation on an ongoing basis in the web-based interface server 2. The school attendance data associated with each student is tracked, recorded and reported to previously designated parties automatically in real-time. The parties receiving the school attendance data reports may include students, teachers, school administrators, district administrators, parents, and community groups. The system is configured to enable programming of varying user account access levels, whereby a student user, teacher user, administrative faculty user, and third party users all have different access levels to student attendance and performance data stored in the system.

Web-based interface server 2 also allows a student to earn award credits for class and school attendance in real-time and immediately updates a student award credit accumulation account balance stored in web-based interface server 2 data storage. The computer implemented student attendance tracking and award credit accumulation system includes a plurality of data input terminals 10, 32, 36, 42, 62, 64, that are connected to the web-based interface server 2 via the Internet 4 in order to facilitate transmission of student identification data from a data input terminal to the web-based interface server 2 for processing. The web-based interface server 2 processes data received from a data input terminal in order to determine the check-in time for a student which the web-based interface server 2 utilizes to determine whether a student is absent from school, tardy for school, on time for school, absent from a scheduled course, tardy for a scheduled course, or on time for a scheduled course. The web-based interface server 2 further processes each transmission of data received from a data input terminal in order to determine the check-in time for a student which the web-based interface server 2 utilizes to determine student award credits earned. In operation, the web-based interface server 2 combines a student award credit balance previously earned with the student award credit being earned in real-time to create an updated student award credit balance that is stored in the web-based interface server data storage.

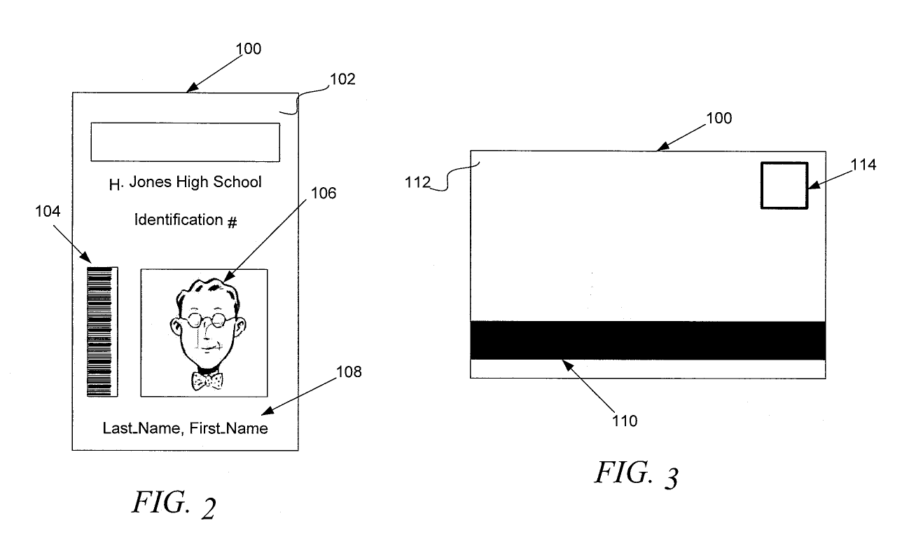

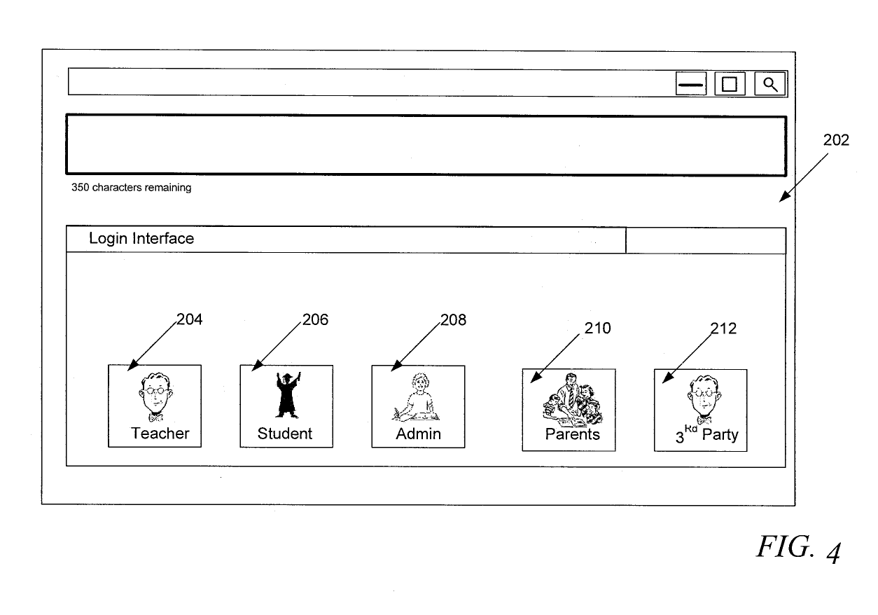

As illustrated, data input terminal 10 is a kiosk system configured to retrieve student identification data. Kiosk system 10 includes interface screens 14, 18 for the display of data transmitted from the web based interface server 2, such as, student communications data and advertising data received from web-based interface server 2. The kiosk system 10 further includes a student identification retrieval device 20. In the embodiment disclosed in FIG. 1, the student identification retrieval device 20 comprises a card swipe communication system positioned on an edge of the kiosk system 10 for ease of swiping student identification cards 100 such as the student identification card illustrated in FIGS. 2 and 3. As FIG. 2 illustrates, the front of a student identification card 102 may include the name of the school, school district information, student first and last name 108, a barcode including student identification data 104, and a picture of the student 106. The back 112 of a student identification card 100 includes at least a magnetic stripe 110 that includes student identification data and other school related indicia. In alternative embodiments, student identification card 100 shall include an RFID identifier connected to the student identification card 100.

Referring back to FIG. 1, the data input terminals 32, 36 that are connected to the web-based interface server 2 via the Internet 4 are desktop workstations 32, and laptops 36 that include a student identification retrieval device such as the card swipe communication system 38, 34, which are operatively connected to the data input terminals 32, 36 by a wireless or hard wire connection such as a USB or other connection system. The data input terminals 42 that are connected to the web-based interface server 2 via the Internet 4 also include a student identification retrieval device 44 that is operatively connected to the data input terminal 42 by way of wireless or hardwired connection such as a USB or other connection system. As FIG. 1 illustrates, the student identification retrieval device 44 comprises an RFID receiver configured to receive student identification data from identification data transmitted from an RFID identifier 48 attached and stored on a student identification card 46 such as that disclosed in FIGS. 2 and 3.

Data input terminals 62, 64 or also connected to the web-based interface server via the Internet 4. Data input server 62 is a computing system operated by a third-party, such as an interested local citizen who desires access to non-confidential student achievement and attendance data. The interested third party may also be an advertiser or other interested party who desires to present local ads to students, teachers, administrators and parents that are connected to the web-based interface server 2. The third-party advertiser may connect their respective computing system to the web-based interface server 2, via the Internet 4, for accessing third-party advertiser accounts that enable the third-party advertiser to input advertising data within advertising files stored within the web-based interface server 2. The advertising files stored within the web-based interface server 2 data storage are accessed by the web-based interface server processor in order to facilitate the transmission of advertising data for display on an interface screen operatively connected to the web-based interface server 2 for display to students, teachers, and administrative faculty. Advertising display data may be displayed based on defined user groups. For example, advertisements for teenage females are not advertisements that will be displayed to teenage boys, teachers, administrative faculty or parents. Data input terminal 64 is connected to the web-based interface server 2 via the Internet 4 to facilitate user access to publicly available information, or student data to which a third-party has been granted access. For example, parents entering the system through third-party access data input terminal 64 via the Internet 4 shall have access to specific student data files to which they are associated and the attendance and reward data stored within the web-based interface server 2.

During operation of the system, the web-based interface server 2, upon a determination that a student is absent from school or any scheduled courses on days for which the student is scheduled to be in school or in a scheduled course without an excuse, the web-based interface server 2, processes the student record associated with the student to determine notification instructions and transmits and attendance electronic data message to at least one communication device address referenced in the student record. The communication device addresses referenced in the student record include email addresses, SMS numbers, mobile phone numbers for electronic messages such as text messages for transmission to tablets 52, smart phones 54, and email accounts and applications associated with third party data input terminals 64. The communication device addresses referenced in the student record further includes mobile and hard-line phone numbers for transmitting automatically computer-generated voice messages reflecting the attendance electronic message report in an automated telephone call initiated by the web-based interface server 2.

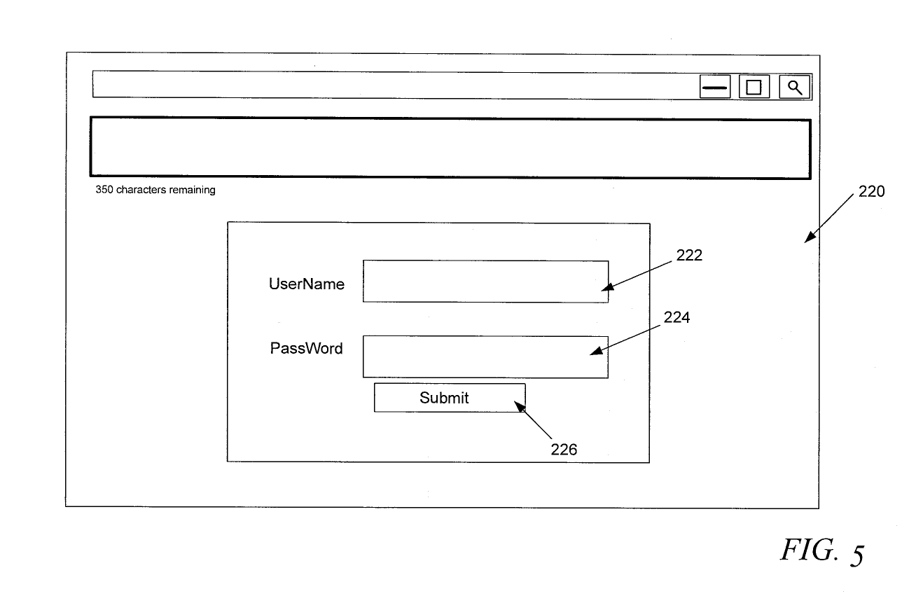

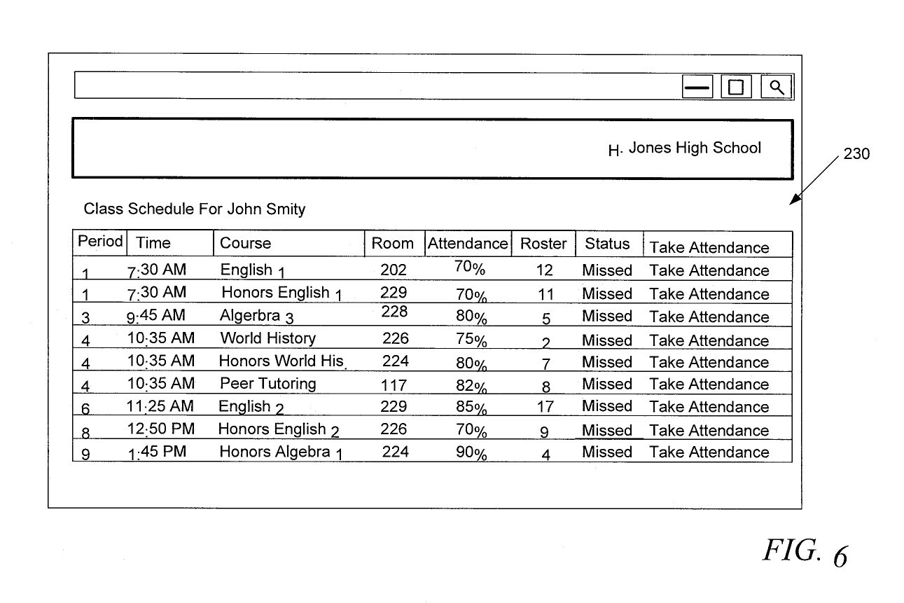

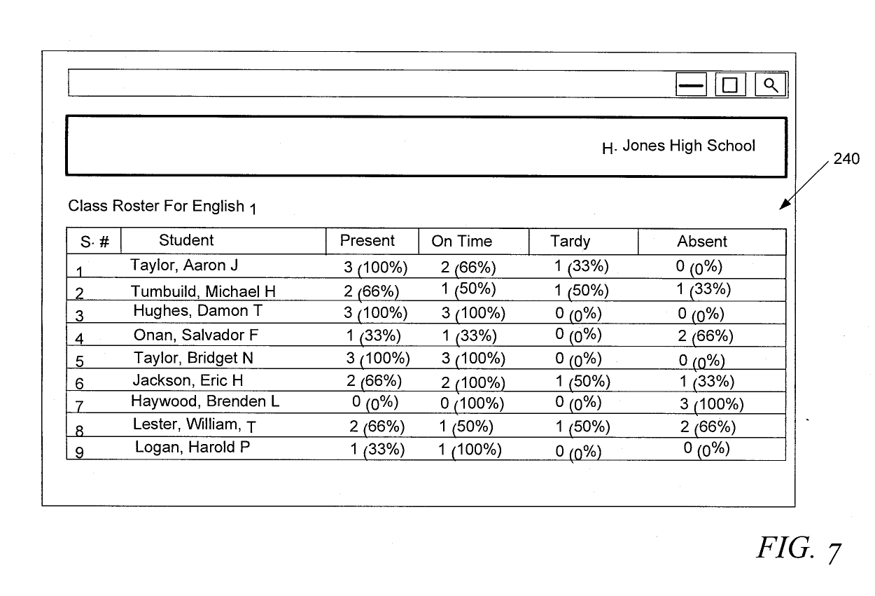

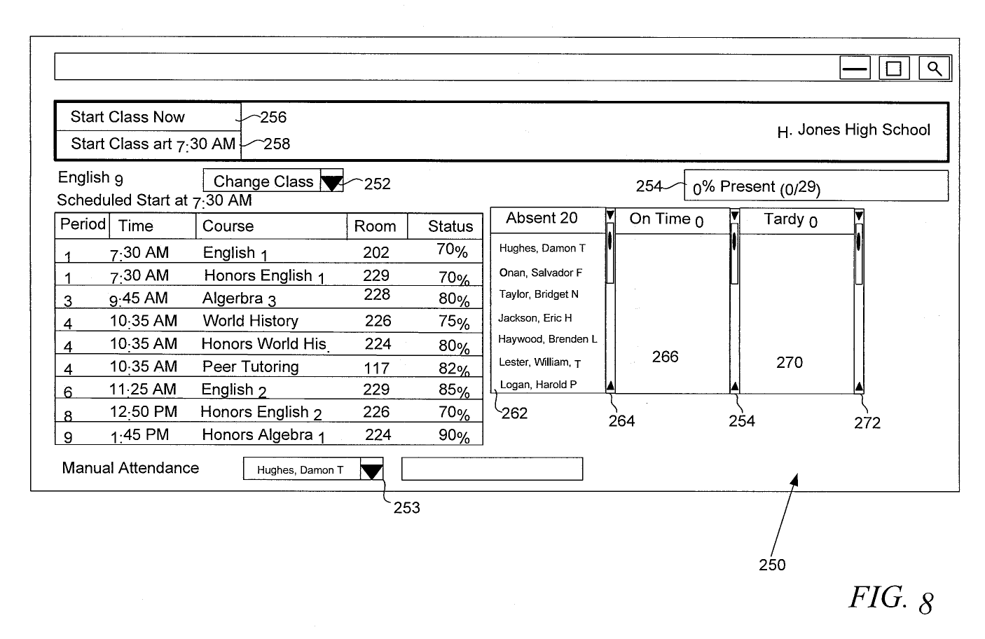

Referring to FIG. 4, a graphical user interface illustrating a login interface 202 is displayed. As illustrated, the login interface 202 includes a plurality of specific log in portals, for teachers, 204, students, 206, administrative faculty 208, parents 210, and third-party groups 212. Upon accessing the system using a specific log in portal, as illustrated in FIG. 5 the graphical user interface displays the login security graphical user interface display 220 configured to allow a user to input a username 222 and a password 224 and select a submit button 226 to thereby submit the username and password to the web-based interface system 2 to gain access to secure data. Upon accessing the web-based interface system 2, as illustrated in FIG. 6, a graphical user interface display 230 let displays a class schedule for a teacher John Smity. As illustrated, the specific teacher graphical user interface display illustrates the teachers schedule that includes the period, time, courses taught by the teacher, the rooms in which the courses are taught, student attendance data, roster data, status of the class, and attendance data. Upon selection of a course, such as English 1, the graphical user interface display for a classroom roster 240 is displayed, as illustrated in FIG. 7, displaying the students identification number, student name, number of times and percentage of time that the student has been present, number of times and percentage of time that the student has been on time, number of times and percentage of time that the student has been tardy, and the number of times and percentage of time that the student has been absent.

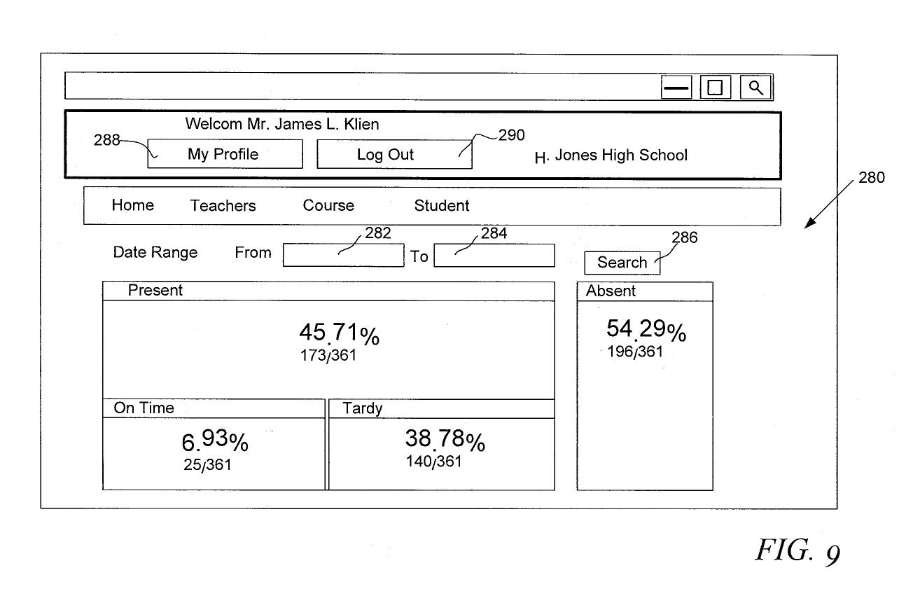

FIG. 8 illustrates an attendance graphical user interface display 250 that allows a teacher to monitor attendance based on student check-in by way of a student identification retrieval device such as a card swipe communication system or an RFID receiver that checks-in a student in response to the RFID receiver receiving student identification data from the identification data transmitted from an RFID identifier attached and stored on a student identification card. Graphical user interface 250 also includes interactive buttons that allow a teacher to record when classes started 256, an interactive button that allows for class to be started at the appropriate time automatically 258, an interactive button that allows the teacher to change the class to the appropriate class and roster, and a manual attendance drop-down menu 253 that enables the teacher to manually take attendance in the system if for some reason the student identification retrieval device is not retrieving student identification data for checking in.

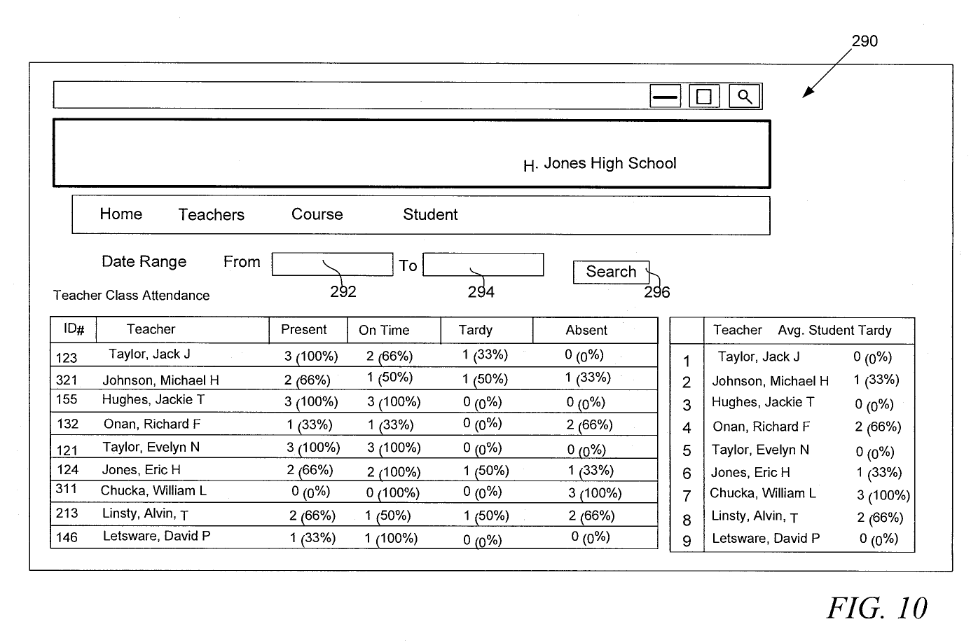

FIG. 9 is an administrator graphical user interface display that allows administrative faculty associated with a specific institution to view all attendance, in real-time, for the institution to which they are associated within web-based interface system 2. The administrative faculty they have access to their profile by engaging be my profile button 288, may logout of the system by engaging button 290, and filter search attendance data for a school during specific date ranges in response to inputting a start date 282 and an end date 284 for the filter query in question. The search may be engaged upon selecting the search button 286.

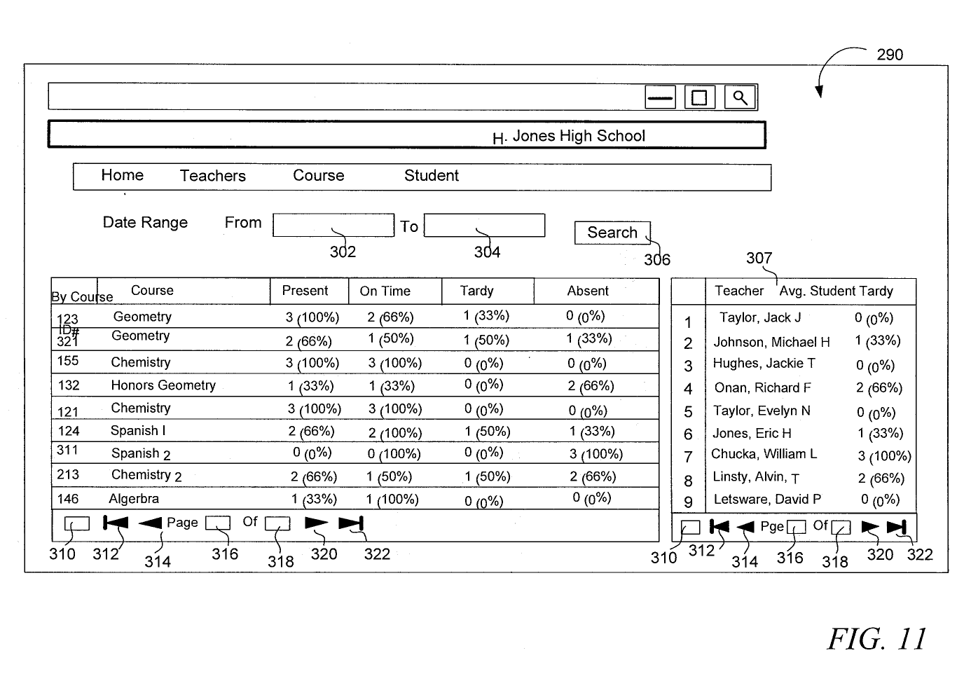

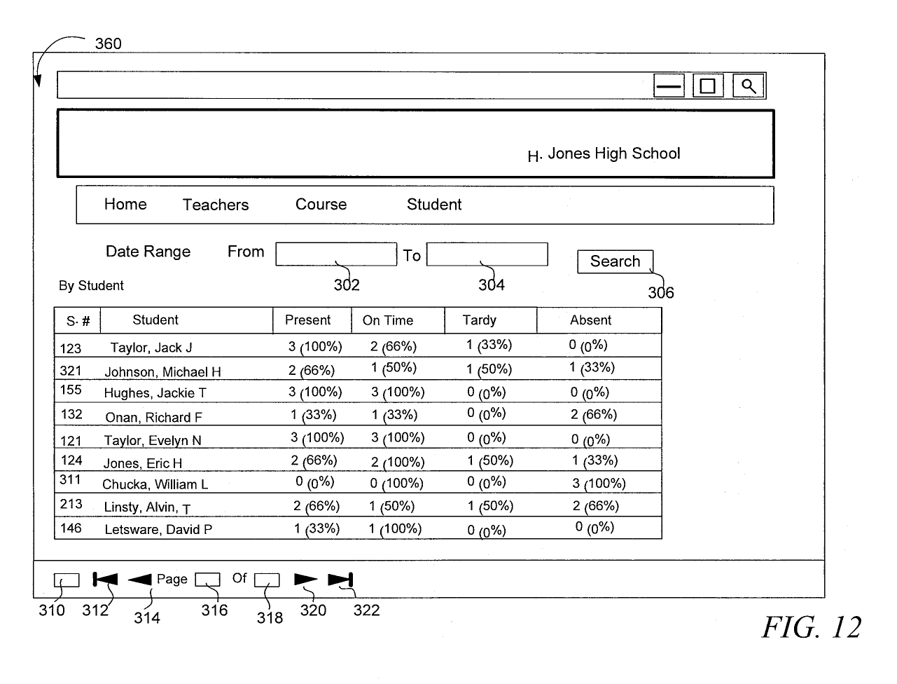

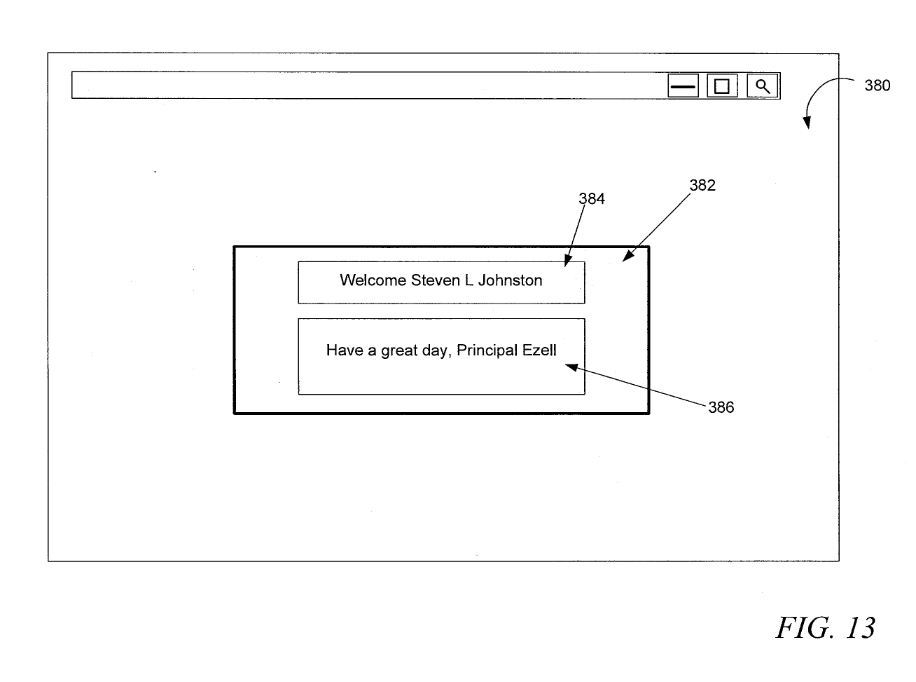

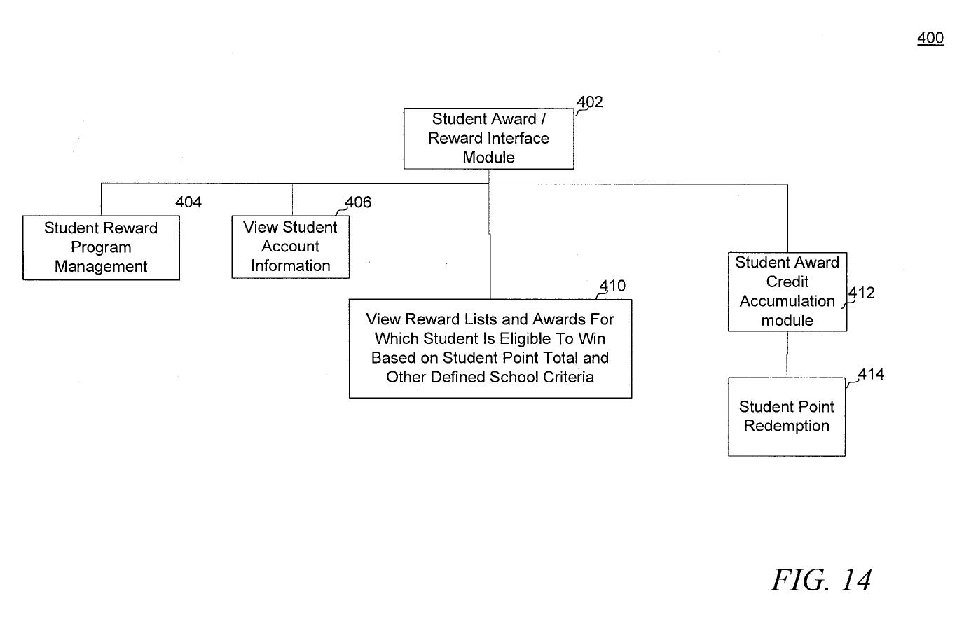

FIG. 10 is an administrator graphical user interface display that allows an administrator to filter search and navigate by teacher classes. As illustrated, student attendance data for a teacher is illustrated showing the number of students that are present, on time, tardy, or absent. FIG. 11 is an administrator graphical user interface display that allows an administrator to filter search and navigate by courses. FIG. 12 is an administrator graphical user.interface display that allows an administrator to filter search and navigate by students under the management of the administrator. FIG. 13 is a attendance graphical user interface display 380 that may be displayed on the kiosk or a data input terminal following check-in by a student by swiping a card, or the student having the RFID identifier attached and stored on their respective student identification card be proximate the RFID receiver. As illustrated in FIG. 13, user interface display 380 displays a message box 382, that includes a welcome message 384 from the web-based interface server 2 and a message previously stored on the web-based interface server 2 by an administrator 386.

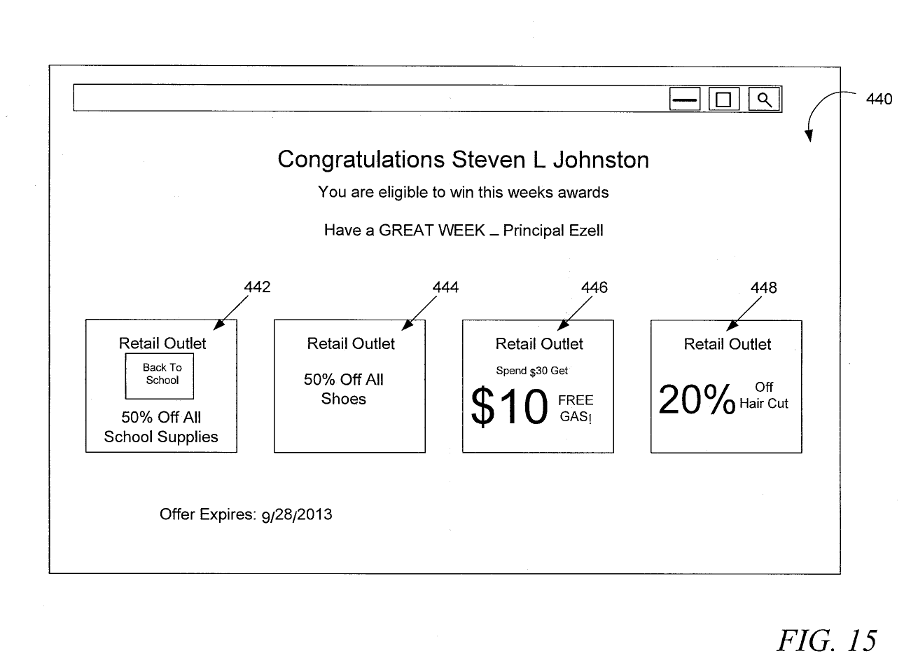

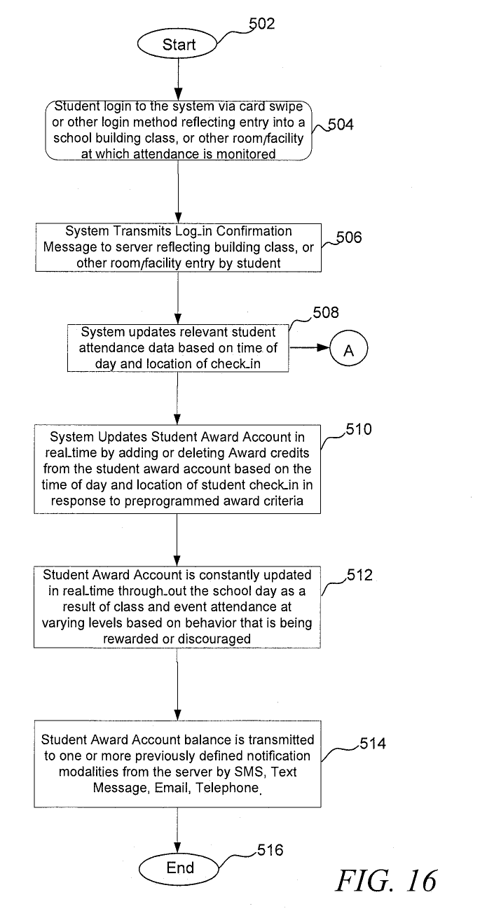

FIG. 14 illustrates a student award/reward interface module 402 that includes a student reward management program module 404, an interface module that enables authorized users to view student account information 406, a reward offering module that enables an authorized user to view award lists and awards for which a student is eligible to win based on a student point total and other defined school criteria 410, a student award credit accumulation module 412, and a student a student award redemption module 414. FIG. 15 illustrates a graphical user interface 440 displayed to a student on a kiosk or a data input terminal display screen following a student achieving sufficient award credits to be eligible to win awards. As illustrated in FIG. 15, the awards may be a plurality of items such as discounts on school supplies 442, discount on shoes 444, a reduction in gas price coupon 446, and a coupon for 20% off of a haircut 448.

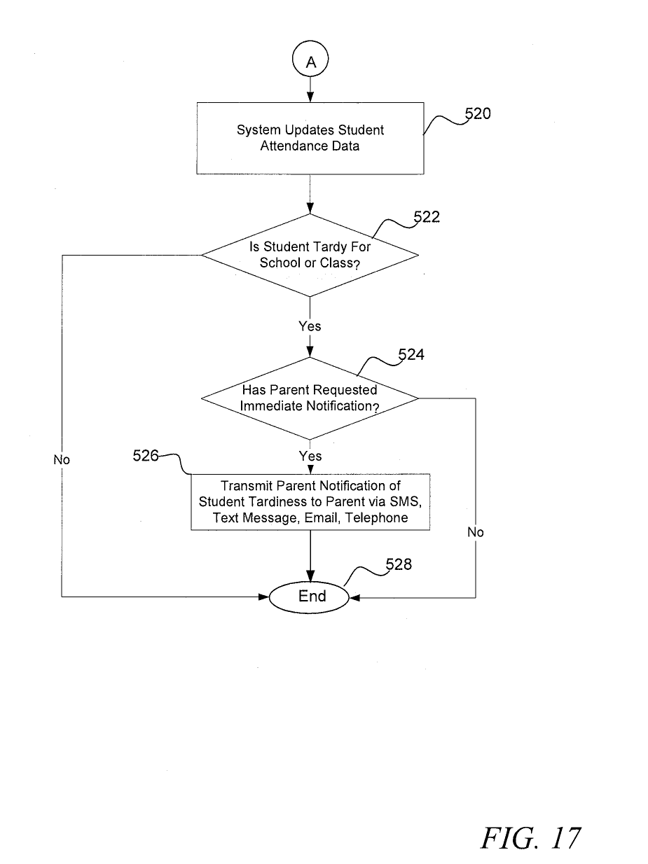

FIG. 16 illustrates the process flow upon a student checking in to the web-based interface server 2. Upon starting 502, a student logs into the system via card swipe or other login method reflecting entry into a school building, course classroom, or other room/facility at which attendance is being monitored by a school 504, such as a game, weekend event, community service event, etc. Next the system transfers a login confirmation message to the web-based interface server to reflect that the building, course classroom, or other room/facility has been entered and checked into by the student at a specific time 506. The system updates the relevant student attendance data stored within the web-based interface server 2 based on the time of day and location of check-in for the student 508. Next, the system updates a student's award accumulation account in real time by adding or deleting award credits from the student award account based on the time of day and location of student checking-in, in response to preprogrammed award criteria. The student award accumulation account is constantly updated in real-time throughout the school day as a result of class and event attendance occurring at varying levels based on behavior that is being rewarded or discouraged 512. Each school has the ability to define the criteria and metrics that enable students to gain earn rewards, thereby enabling students to have individual award accumulation plans eliminating a one-size fits all reward system and enabling incremental change within all students based on the behavior that needs to be modified. Next the student award account balance is transmitted to one or more previously defined notification modalities from the web-based interface server by SMS, text message, email, or recorded voice message to a telephone 514.

As illustrated in FIG. 17, the web-based interface determines the update to student attendance data based on the time of day and location of the student checking in 520 by determining if the student is tardy or absent from school or scheduled course without an excuse, the system records that the student is present and or has not has not checked in to school or a scheduled course late. If the system determines that a student is tardy or absent from school or a scheduled course without an excuse, the web-based interface server checks the system to determine whether a parent has requested immediate notification 524 and, upon the system validating that the parent has requested notification, and notification data has recorded and stored within the system and is accessible, the system transmits parent notification of student absence or tardiness to the parent via SMS, text message, email, or computer-generated telephone message to a mobile or landline telephone.

While certain features and embodiments of the invention have been described, other embodiments of the invention will be apparent to those skilled in the art from consideration of the specification and practice of the embodiments of the invention disclosed herein. Furthermore, although embodiments of the present the virtual device 450 within the virtual device in the embodiment shown invention have been described as being associated with data stored in memory and other storage mediums, one skilled in the art will appreciate that these aspects can also be stored on or read from other types of computer-readable media, such as secondary storage devices, like hard disks, floppy disks, or a CD-ROM, a carrier wave from the Internet, or other forms of RAM or ROM. Further, the steps of the disclosed methods may be modified in any manner, including by reordering steps and/or inserting or deleting steps, without departing from the principles of the invention.

It is intended, therefore, that the specification and examples be considered as exemplary only, with a true scope and spirit of the invention being indicated by the following claims and their full scope of equivalents.

What is claimed is:

1. A computer implemented student school attendance tracking and award credit accumulation system in which class and school attendance data associated with a student is tracked, recorded and reported to select parties in real-time, and wherein a student earns award credits for class and school attendance in real-time and the system immediately updates a student award credit accumulation balance stored at a web based interface server, the system comprising:
a plurality of data input terminals; and
a web based interface server;
wherein the web based interface server includes a storage area for storing student records including data representative of student personal information, student attendance and the student award credit accumulation balance;
wherein the plurality of data input terminals are connected to the web based interface server to facilitate transmission of student identification data to a processor within the web based interface server for processing to log the time for student check in to determine whether a student is at least one of absent, tardy, and on-time for at least one of a school day and a plurality of scheduled courses;
wherein the web based interface server:
processes each transmission of student school attendance data to determines student award credits earned;
combines a student award credit balance previously earned with the student award credit earned to create an updated student award credit balance; and
updates the student award credits earned that are stored in the web based interface server with an updated student award credit balance.

2. The system of claim 1 wherein the data input device comprises a kiosk system including at least:
a student identification retrieval device for retrieving student identification data; and
an interface screen for display of data transmitted from the web based interface server.

3. The system of claim 2 wherein the student identification retrieval device comprises a card swipe communication system operatively configured to determine student identification from a magnetic stripe on a student identification card.

4. The system of claim 1 wherein the data input device comprises a computing system operatively connected to a student identification retrieval device for retrieving student identification data, wherein the computing system includes an interface screen for display of data transmitted from the web based interface server.

5. The system of claim 4 wherein the student identification retrieval device comprises a card swipe communication system operatively configured to determine student identification from a magnetic stripe on a student identification card.

6. The system of claim 4 wherein the student identification retrieval device comprises a RFID receiver for receiving student identification data from identification data transmitted from an RFID identifier attached and stored on a student identification card.

7. The system of claim 1 wherein upon a determination that a student is at least one of absent and tardy for at least one of a school day and a course, the web based interface server, processes the student record associated with the student to determine notification instructions and transmits an attendance electronic data message to at least one communication device address referenced in the student record.

8. The system of claim 7 wherein the communication device address includes at least one of an email address, a SMS number, a text message number, and a telephone number.

9. The system of claim 7 wherein the attendance electronic data message comprises an automatically computer generated voice message and the transmission of the attendance electronic data message comprises an automated phone call initiated by the server.

10. The system of claim 1 wherein the data input device comprises a computing system operatively connected to the web based interface server for accessing third party accounts that enable the input of advertising data within advertising files stored within the web based interface server, whereby the advertising files are accessed by the web server and advertisements are displayed on an interface screen operatively connected to the web interface server for display of third party advertisements.
